(19) United States
(12) Patent Application Publication
(10) Pub. No.: US 2007/0007275 A1
(43) Pub. Date: Jan. 11, 2007

(54) Plant shade

(76) Inventor: David G. Berg, White Lake, MI (US)

Correspondence Address: Douglas L. Wathen;Gifford, Krass, Groh, Sprinkle,, Anderson & Citkowski, PC, PO Box 7021, Troy, MI, 48007-7021, US

(21) Appl. No.: 11/477,579

(22) Filed: Jun. 29, 2006

Related U.S. Application Data
(60) Provisional application No. 60/697,040, filed on Jul. 6, 2005.

(51) Int. Cl. H05B 3/68

(52) U.S. Cl. 219/448.11

(57) ABSTRACT

A shade is designed for use with a hanging pot of the type having a pot portion with an upwardly facing plant-receiving area and one or more upwardly extending members for supporting the pot portion in a hanging position. The shade includes a shade element with a central region and an outwardly extending perimeter region. The central region includes a connection feature configured to interconnect the shade element with one or more upwardly extending members of the hanging pot so as to position the shade element above the plant-receiving area.

### REFERENCE TO RELATED APPLICATION

This application claims priority from U.S. Provisional Patent Application Ser. No. 60/697,040, filed Jul. 6, 2005, the entire content of which is incorporated herein by reference.

### FIELD OF THE INVENTION

The present invention relates generally to containers and accessories for plants and, more specifically, to a cover or shade for use with or in combination with a pot or container for a plant.

### BACKGROUND OF THE INVENTION

Growing and displaying plants, such as ornamental plants, flowers, herbs, and vegetables, is popular and widespread. Often, such plants are placed in pots so that they can be moved around or hung. As professional gardeners are aware, some plants thrive in full sun, while others do better in partial or full shade. A partial or full shade plant, if placed in direct sun for an extended period of time, may fail to thrive, become unattractive, or die. As such, plants that cannot tolerate full sun should not be placed in a very sunny spot. However, many plant purchasers either do not recognize this limitation, fail to follow the growing instructions, or prefer to locate the plant in a sunny position for appearance or other reasons. This is especially true with hanging potted plants. Such potted plants are very popular, and are often hung in a highly visible position which happens to be in full sun. Depending on the plant in the pot, the plant may fail to thrive due to excess sun exposure.

In light of the above, there is an ongoing need for apparatus that allow a plant to be positioned as desired.

### SUMMARY OF THE INVENTION

The present invention provides a shade for a hanging pot of the type having a pot portion with an upwardly facing plant-receiving area and one or more upwardly extending members for supporting the pot portion in a hanging position. The shade includes a shade element with a central region and an outwardly extending perimeter region. The central region includes a connection feature configured to interconnect the shade element with one or more upwardly extending members of the hanging pot so as to position the shade element above the plant-receiving area.

The present invention also provides a plant holder including a hook for supporting the plant holder and a shade element interconnected with the hook. The shade element has a central region and an outwardly extending perimeter region. The shade element has opposed upper and lower surfaces. The plant holder also includes a pot for supporting a plant. The pot is interconnected with the hook and disposed below the shade element.

### BRIEF DESCRIPTION OF THE DRAWINGS

FIG. 1 is a perspective view of a first embodiment of a shade according to the present invention with a hanging pot;

FIG. 2 is a top view of the shade of FIG. 1;

FIG. 3 is a cross-sectional side view of a second embodiment of the plant shade according to the present invention with a non-hanging pot;

FIG. 4 is a detailed view of a portion of the shade shown in FIG. 3;

FIG. 5 is a perspective view of a third embodiment of a plant holder according to the present invention; and

FIG. 6 is a cross-sectional detailed view of a portion of the shade for the plant holder of FIG. 5.

### DETAILED DESCRIPTION OF THE PREFERRED EMBODIMENTS

The present invention provides several alternative designs for a plant shade or a plant holder with a shade. Such a shade allows some or all of the sun that would otherwise strike a plant to be blocked.

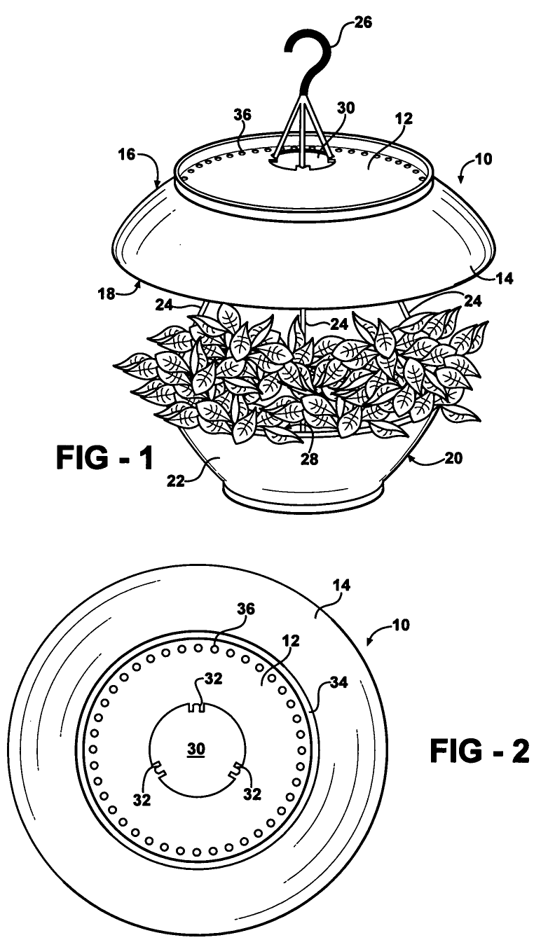

FIGS. 1 and 2 show a first embodiment of a plant shade 10 according to the present invention. The shade 10 has a central region 12 and a perimeter region 14 that extends outwardly from the central region. The shade 10 has an upper surface 16 and an opposed lower surface 18. In the illustrated embodiment, the lower surface is concave. As best shown in FIG. 1, the shade 10 is designed for use with a hanging pot 20 of the type having a pot portion 22 and several upwardly extending members 24 that interconnect the pot portion 22 with a hook 26. The pot portion 22 has an upwardly facing plant-receiving area 28.

In this embodiment of the shade 10, the central region 12 has a central opening 30 with three inwardly extending engagement members 32. The engagement members engage the support members 24, and serve as a connection feature. As will be clear to those of skill in the art, the shade may include additional or other types of connection features for interconnecting with the support members 24. As best shown in FIG. 1, each of the engagement members rests on one of the support members 24 so that the shade 10 is supported above the pot portion 22 and provides some shade for a plant therein. Because of the design, the shade 10 may be easily added or removed from the hanging pot 20 depending on the position of the pot and the type of plant.

In the illustrated embodiment, a ring-shaped gutter element 34 extends upwardly from the upper surface 16 of the shade element 14 so as to define a wall that surrounds the central region 12. This serves to catch some water that falls on or is poured on the upper surface 16 in the central region 12. A plurality of holes 36 are provided in the central region 12 such that water caught by the gutter element 34 drains through onto the plant below the shade. This allows for easy watering, and also allows some rain to be caught and directed to the plant.

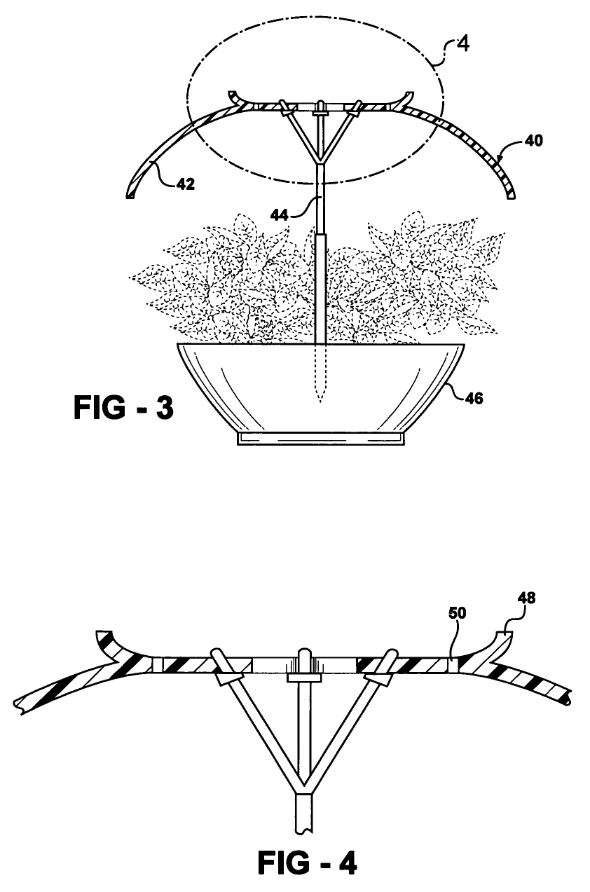

Referring now to FIGS. 3 and 4, a second embodiment of a shade according to the present invention is shown generally at 40. The shade 40 includes a shade element 42 with a shape similar to the design of FIG. 1, and a support 44. The support 44 has an upper end that supports the shade element and lower end that engages a pot 46 or the soil in the pot. FIG. 4 shows a detailed view of the area indicated in FIG. 3. This detailed view shows the interconnection of this embodiment with the support 44 as well as a curved gutter element 48 and drain holes 50.

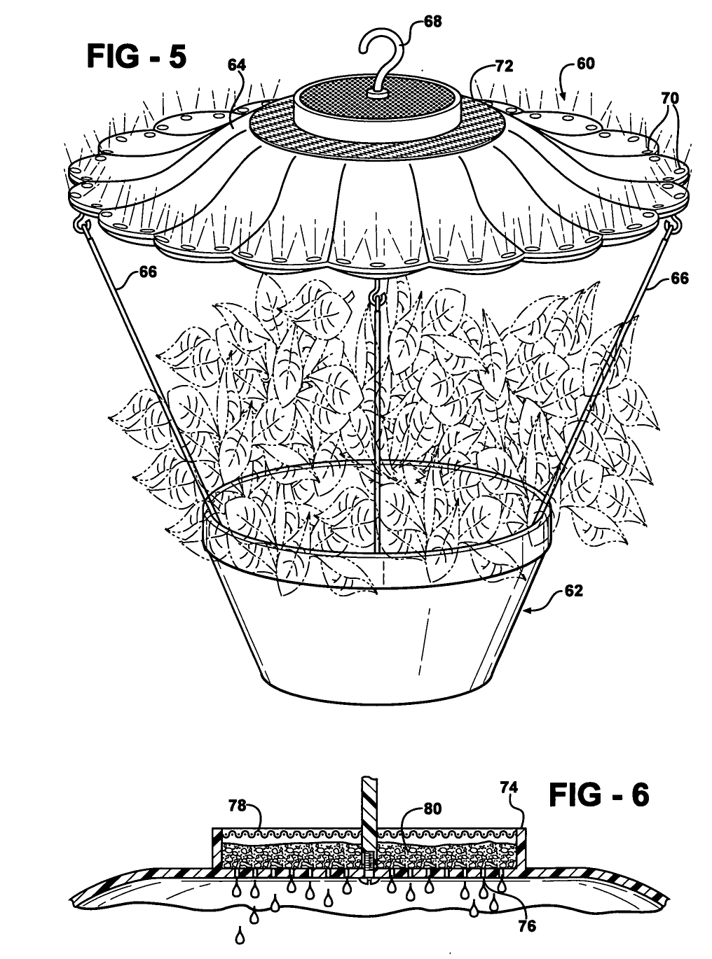

Turning now to FIGS. 5 and 6, a third embodiment of the present invention is shown. In this embodiment, the combination of a shade 60 and pot 62 are provided as a plant holder assembly. This embodiment also illustrates an alternative shape for the shade element 64. As will be clear to those of skill in the art, the shade element may have a variety of sizes and shapes to suit various aesthetic and functional requirements. In this embodiment, a plurality of support elements 66 interconnect the perimeter of the pot 62 with the perimeter of the shade element 64. Alternatively, the pot 62 may be interconnected with the hook 68 in a way similar to that shown in FIG. 1. This embodiment is also shown with a plurality of lights 70 around the perimeter of the shade element 64. In the illustrated embodiment, the lights 70 are upwardly directed, but may be alternatively or additionally outwardly directed or downwardly directed. The illustrated embodiment shows a plurality of rounded disc-shaped small lights. The lights may have other shapes, or may take the form of tube lamps, such as neon or fluorescent. LEDs, either clear or colored, may also be used and provide energy efficiency benefits. The lights 70 may be powered by an energy storage device, such as a battery, or from a transformer or AC power. In the illustrated embodiment, a solar cell 72 is provided on the upper surface of the shade element 64 for recharging a storage element. This allows the device to act as a solar light. Preferably, during daylight hours the solar cell 72 charges the storage device. When it becomes dark, the lights 70 come on and use power from the storage device.

In the illustrated embodiment, a gutter element 74 is provided around a small central region and a plurality of holes 76 allow water to drain from the central region inside the gutter element 74 to the plant. A grille 78 is provided to cover this region with the grille being porous to water. Fertilizer 80 may be placed in this region such that water poured or raining through the grille 78 dissolves a portion of the fertilizer such that it falls on the plant. The fertilizer may be specially formulated to avoid damage to the plant foliage.

As will be clear to those of skill in the art, the various embodiments of the present invention may be altered without departing from the scope or teaching of the present invention. As a few examples, the shade elements may be provided with or without gutter elements, with or without holes, and in other sizes and shapes. As further alternatives, the shade may be made completely opaque, somewhat translucent or fully translucent. For example, the shade may be constructed of a material that allows some sunlight to pass through it for a plant that requires some sun, but not full sun. Interchangeable shades may also be provided, or different shades with different transmissivities may be combined or stacked to provide the desired amount of light transmission. An adjustable shade may also be provided by providing louvers or slats that may be opened or closed so as to allow more or less light to pass through. Further, a fully transparent version may be useful where a purchaser wishes to protect a plant from falling debris or wishes to use the gutter or fertilizer function described above, but does not need to protect the plant from the sun. Further variations will be clear to those of skill in the art.

I claim:

1. A shade for a hanging pot of the type having a pot portion with an upwardly facing plant receiving area and one or more upwardly extending members for supporting the pot portion in a hanging position, the shade comprising:
a shade element having a central region and an outwardly extending perimeter region, the central region including a connection feature configured to interconnect the shade element with the one or more upwardly extending members of the hanging pot so as to position the shade element above the plant receiving area.

2. The shade according to claim 1, wherein the shade element has a concave lower surface.

3. The shade according to claim 1, wherein the central region has an opening defined there through, the connection feature comprising inwardly extending engagement members for engaging the upwardly extending members.

4. The shade according to claim 1, wherein upper surface of the shade element has a gutter element defined around the central region for retaining water and a plurality of holes for draining the water onto a plant in the pot.

5. The shade according to claim 4, further comprising a grill selectively received by the gutter element so as to define a fertilizer receiving area between the grill and the upper surface of the shade element.

6. The shade according to claim 1, further comprising a plurality of lights on the shade element.

7. The shade according to claim 6, further comprising a solar cell and an energy storage device for powering the lights.

8. The shade according to claim 1, wherein the shade element is opaque.

9. The shade according to claim 1, wherein the shade element is at least partially translucent.

10. A plant holder comprising:
a hook for supporting the plant holder;
a shade element interconnected with the hook, the shade element having a central region and an outwardly extending perimeter region, the shade element having opposed upper and lower surfaces; and
a pot for supporting a plant, the pot being interconnected with the hook and disposed below the shade element.

11. The plant holder according to claim 10, further comprising a plurality of support members interconnecting the pot with the shade element, the pot being interconnected with the hook by the shade element and support members.

12. The plant holder according to claim 10, wherein the shade element has a concave lower surface.

13. The plant holder according to claim 10, wherein upper surface of the shade element has a gutter element defined around the central region for retaining water and a plurality of holes for draining the water onto a plant in the pot.

14. The plant holder according to claim 13, further comprising a grill selectively received by the gutter element so as to define a fertilizer receiving area between the grill and the upper surface of the shade element.

15. The plant holder according to claim 10, further comprising a plurality of lights on the shade element.

16. The plant holder according to claim 15, further comprising a solar cell and an energy storage device for powering the lights.

17. The plant holder according to claim 10, wherein the shade element is opaque.

18. The plant holder according to claim 10, wherein the shade element is at least partially translucent.
